(19) United States
(12) Patent Application Publication
(10) Pub. No.: US 2011/0082628 A1
(43) Pub. Date: Apr. 7, 2011

(54) CRUISE CONTROL MODIFICATION

(75) Inventor: Brendan J. Murnane, Millwood, NY (US)

(73) Assignee: Brendan J. Murnane, Millwood, NY (US)

(21) Appl. No.: 12/899,166

(22) Filed: Oct. 6, 2010

Related U.S. Application Data
(60) Provisional application No. 61/249,031, filed on Oct. 6, 2009.

(51) Int. Cl. G06F 7/00; B60T 7/12; B60W 10/18; B60W 30/14; B60Q 1/00

(52) U.S. Cl. 701/48; 701/36; 340/439

(57) ABSTRACT

A cruise control modification device includes a triggering mechanism that activates one or more sensors in the vehicle steering wheel. The sensors are adapted to sense that pressure is being continuously applied to the wheel by the vehicle's operator. A kill switch mechanism is in communication with the sensors and is adapted to shut off the vehicle's cruise control operation when a signal is received form the sensors that the operator has ceased applying pressure to the steering wheel, e.g. while falling asleep. The kill switch may be in further communication with the vehicle's braking system, hazard lights, interior lights and a sound alarm to alert the driver.

### BACKGROUND OF THE INVENTION

This invention relates to a motor vehicle cruise control system modification device which shuts off the cruise control feature and warns the driver if insufficient pressure is applied to the steering wheel, e.g. if the driver falls asleep. The applicant claims the benefits under Title 35, United States Code, Section 119(e) of prior U.S. Provisional Application No. 61/249,031 which was filed on Oct. 6, 2009.

### FIELD OF THE INVENTION

Drivers traveling long distances on highways are more likely to use Cruise Control than those who are driving short distances on roads with more congestion. These same long distance drivers are also more likely to fall asleep behind the wheel. When people fall asleep while driving vehicles, their hands often fall off the wheel as they lose consciousness. The vehicle usually slows down on its own, because the driver is no longer applying pressure to the gas pedal.

When drivers are using Cruise Control and fall asleep behind the wheel, however, a more dangerous situation is created for themselves as well as for others on and off the road, because the set speed is maintained while the driver is asleep.

### DESCRIPTION OF THE INVENTION

In accordance with my invention, near the button or lever that activates Cruise Control there is a second triggering mechanism that can initiate a Cruise Control Kill Switch mechanism. This activates one or more sensors in the steering wheel. As long as pressure on the wheel is maintained, Cruise Control continues.

When sensors in the steering wheel no longer detect the driver's hands, the cessation of pressure there is communicated to the Kill Switch mechanism which is adapted to shut off the vehicle's Cruise Control operation. The vehicle will automatically start decelerating, and optionally the Kill Switch mechanism may further communicate with the vehicle's braking system to commence braking the vehicle. The Kill Switch mechanism may further communicate with the vehicle's hazard lights, interior lights and/or an interior sound alarm to (a) turn on the vehicle's flashing hazard lights to alert other drivers of the decrease in speed, (b) turn on the lights inside the vehicle and/or (c) sound an alarm inside the vehicle to awaken the driver. All four responses will end when Cruise Control is affirmatively turned off by the driver, either manually or by braking.

Without my invention, a driver who falls asleep at the wheel while using Cruise Control loses control of his or her vehicle at the set speed. With my invention, if the driver has activated the Kill Switch, then sensors in the steering wheel will detect the absence of the driver's hand pressure on the wheel, the vehicle will slow down and alert the driver, thereby saving him or her from an accident.

These settings are not required for all Cruise Control use. The invention is an optional safety precaution for those who fear falling asleep behind the wheel.

### Setting the Device

The button or switch that activates the “Kill Switch” is located near what triggers the Cruise Control setting. Disarming the “Kill Switch” is accomplished in the same manner as disarming the Cruise Control.

### Wheel

The wheel will include an interior sensory system. By the driver gripping the wheel or simply applying pressure, the sensors will register that the driver is conscious and in control of the vehicle. If pressure is released entirely from the wheel, this will trigger the Kill Switch mechanism.

### Alarm

Once there is no longer pressure on the wheel, the Kill Switch mechanism is activated with the following result:
(a) Cruise Control will be turned off, and the vehicle will start decelerating, with or without braking;
(b) The exterior hazard lights may be turned on to alert other drivers of the deceleration;.
(c) The interior lights may turn on to help awaken the driver; and
(d) An alarm within the vehicle may sound to further help awaken the driver.

What is claimed is:

1. A motor vehicle cruise control modification device comprising:
(a) a triggering mechanism that activates one or more sensors in the vehicle steering wheel, such sensors adapted to sense that pressure is being continuously applied to said wheel by an operator of said vehicle; and
(b) a kill switch mechanism in communication with said one or more sensors, wherein said kill switch mechanism is adapted to shut off the vehicle's cruise control operation when a signal is received from said one or more sensors that the operator has ceased applying pressure to the steering wheel.

2. The device according to claim 1 wherein said kill switch mechanism is in further communication with the vehicle's braking system to commence braking of the vehicle when a signal is received from said one or more sensors that the operator has ceased applying pressure to the steering wheel.

3. The device according to claim 2 wherein said kill switch mechanism is in further communication with the vehicle's hazard lights to commence the flashing of said hazard lights when a signal is received from said one or more sensors that the operator has ceased applying pressure to the steering wheel.

4. The device according to claim 3 wherein said kill switch mechanism is in further communication with the vehicle's interior lights to turn on said interior lights when a signal is received from said one or more sensors that the operator has ceased applying pressure to the steering wheel.

5. The device according to claim 4 wherein said kill switch mechanism is in further communication with a sound alarm inside the vehicle to activate the alarm when a signal is received from said one or more sensors that the operator has ceased applying pressure to the steering wheel.

6. The device according to claim 5 wherein the vehicle's braking system is in further communication with the device wherein the braking system is adapted to turn off the vehicle's hazard lights, interior lights and sound alarm when the operator applies pressure to the brake of the vehicle.

7. The device according to claim 6 wherein the triggering mechanism may be manually turned on or off by the vehicle operator.
